(19) United States
(12) Patent Application Publication
(10) Pub. No.: US 2010/0153188 A1
(43) Pub. Date: Jun. 17, 2010

(54) Internet Repository for Employer Provided References for Current and Former Employees

(76) Inventor: Muhammed Al-Amin, Dallas, TX (US)

Correspondence Address: Myers Wilson P.C., 16660 Dallas Parkway, Suite 2500, Dallas, TX, 75248, US

(21) Appl. No.: 12/333,580

(22) Filed: Dec. 12, 2008

(51) Int. Cl. G06Q 10/00; G06Q 30/00; G06F 17/30; G06Q 20/00; G06F 17/40

(52) U.S. Cl. 705/11; 705/26; 707/E17.014; 707/E17.044

(57) ABSTRACT

The present invention is a system and methodology embodied in an Internet Website and associated hardware and software to overcome the problem of a prospective employee providing dubious or fraudulent references. A prospective employer need no longer rely on references of relatives, friends, colleagues and/or acquaintances that have been strategically approached by the prospective employee to provide a ‘good’ and most often ‘exaggerated’ reference. The present invention allows for an employee's prior employer to provide an employee reference to a future employer. Such referrals may be stored, indexed, searched and retrieved by prospective employers thereby enhancing the reliability and credibility of a prospective employee reference. While an employee may dispute a claim in a free form narrative or by uploading responsive documentation, the employee may not provide a referral.

### CROSS-REFERENCE TO RELATED APPLICATIONS

None.

### TECHNICAL FIELD

The present invention is generally a system and method of storing, indexing, searching and retrieving employer provided references as they relate to current and former employees of employers. Employers and employees, whether current, former or prospective, shall logon and access for a preset fee an Internet based portal for the purposes of searching, retrieving, viewing, updating and/or disputing employer provided references and reference documents.

### BACKGROUND

It is well known in the employment industry that prospective employees will attempt to persuade prospective employers into hiring them based on dubious references, the veracity of which are often highly speculative. For instance, prospective employees provided references of relatives, friends, colleagues and/or acquaintances that have been strategically approached by the prospective employee to provide a ‘good’ and most often ‘exaggerated’ reference. A much more accurate reference can be provided by a current or former employer of the prospective employee. An employer provided reference is often more credible, reliable, unbiased and not skewed to favor of the employment of a prospective employee. Further, the reliability of an employer provided reference is enhanced given the fact i) each employer must conform to certain state and federal guidelines concerning the employer-employee relationship; and ii) references are more likely to be supported by documentation or other tangible credible evidence of an employees past transgressions or successes.

There are several websites which provide access by a prospective employer to obtain relevant resumes from prospective employees: monster.com and careerbuilder.com. Employers are known to maintain internet websites for receiving resumes from employees. See U.S. Pat. No. 5,758,324, issued May 26, 1998, to Hartman et al., U.S. Pat. No. 5,884,270, issued Mar. 16, 1999, to Walker et al., and U.S. Pat. No. 5,978,768, issued on Mar. 16, 1999, to McGovern et al. describing a computerized systems for resume storage and retrieval. These foregoing references focus on information provided by the prospective employee, and not employee related reference materials provided by a current or former employer concerning a current, former, or prospective employee.

There exist a plethora of patented internet on-line referral systems: U.S. Pat. No. 5,864,871, issued on Jan. 26, 1999, to Kitain et al. describes an information delivery system wherein one or more second parties (brokerage firms) place information about a first party (a corporation) in a database for viewing by third parties (users). The depositors control who has access to the information, and where the deposit and access of information occur on separate computers in a distributed system. U.S. Pat. No. 6,064,980, issued May 16, 2000, to Jacobi et al., describes a computerized Internet system for recommendations of literary works. U.S. Pat. No. 6,026,374, issued Feb. 15, 2000 to Chess describes a computerized system for generating trusted descriptions of products wherein one or more second parties place information about a first party's product in a node of a network for view by a third party and wherein the database controls the information released to the general public. U.S. Pat. No. 5,758,324, issued May 26, 1998, to Hartman et al., U.S. Pat. No. 5,884,270, issued Mar. 16, 1999, to Walker et al., and U.S. Pat. No. 5,978,768, issued on Mar. 16, 1999, to McGovern et al. Describe computerized systems for resume storage and retrieval, useful in an Internet system. Further, U.S. Pat. No. 6,904,407, issued on Jun. 7, 2005, to Ritzel et al. describes an electronic repository for jobseeker's reference wherein jobseekers give perspective recruiters/employers information on accessing their individual references.

There are also several websites which allow employers, whether current or prospective employers, to do background searches on prospective employees: backgroundchecks.com, intellius.com, and accruint.com. These sites are generally limited to known public information, such as addresses, asset searches, criminal databases or other governmental records, which are combined in a readily accessible format.

The above referenced patents and existing concepts are distinct form the current invention because they remain driven by employee provided referrals, public data or merely provide for the file sharing and/or storage of employee provided information such as curriculum vitas or other self serving documents. Industry today does not place a former employer and a future employer in direct contact through the Internet for purposes of supplying valuable and non-public referral information on a prospective employee. The current invention uniquely eliminates the employee as the originating source of the referrals.

### SUMMARY

The present invention is a system and methodology embodied in an Internet Website and associated hardware and software to overcome the problem of a prospective employee providing dubious or fraudulent references by allowing for referrals directly between employers. A prospective employer need no longer rely on references of relatives, friends, colleagues and/or acquaintances that have been strategically approached by the prospective employee to provide a ‘good’ and most often ‘exaggerated’ reference. Simply put, the present invention allows for an employee's prior employer to provide an employee reference to a future employer. Such referrals may be stored, indexed, searched and retrieved by prospective employers thereby enhancing the reliability and credibility of a prospective employee reference. An employee may dispute a claim in a free form narrative or by uploading responsive rebuttal documentation.

The inventive website operates on the basis that there are two general categories of potential users: employers (current, former or prospective employers) and employees (current, former or prospective employees). By way of example, a prospective employer is assigned a user identification (ID) and password. Upon payment, a prospective employer, using a social security number of a prospective employee or other indexed metric capable of identifying a prospective employee, is able to view employer referrals uploaded into the system by former or current employers.

As a part of viewing employer referrals, the prospective employer may request additional information from the prior employer using free text narratives, system defined narratives or uploaded documents. In addition to viewing the report on a display device such as a computer monitor, a prospective employer can print or save the prospective employee report for later use.

The website assigns a unique user ID and password for all other potential users. By way of example, a former or current employer can be assigned a user identification (ID) and password. Upon payment, said employers, using a social security number of a former or current employee or other indexed metric capable of identifying such employee, are able to amend referral records or create new and additional referral records for these current or former employees. These referral records can be stored using a free text narrative, system defined narratives or uploaded as evidentiary documents of performance such as written accolades or reprimands which are often found in an employee personnel file.

As a part of creating the new or additional referral records, or when requested to do so by a prospective employer, the current or former employer can send supplemental evidentiary materials regarding a current or former employee using free texted narratives, system defined narratives or uploaded documents. The system makes it possible for current and former employers to be in electronic communication with prospective employers as the prospective employer individually evaluates and verifies an employee's qualification. Similarly, a current of former employers may display, print or save employee referral records. Any uploaded employer references, reference documents, and employee disputes, can be selected and formatted by an employee or employer for electronic delivery such as e-mailing, instant messaging, displaying, printing or saving to an employer or employee computer.

While in the current employment environment current and former employers are afraid to discuss an employees qualifications with a potential employer for fear an employee may bring suit against the current or former employer for providing such information. As all employers and employees must opt into the system, this system facilitates unfettered communications between the employers in a structure environment where legal reprisals are adequately managed through appropriate legal agreements provided as a part of the system subscription process. This system promotes the unfettered flow of authentic and highly credible employer referrals. Such referrals are not common in the workplace today. Tangentially, the system will also create a psychological deterrent which may promote higher work ethics and motivation on the part of the employee.

None of the above mentioned inventions and patents, taken either singularly or in combination, is seen to describe the instant invention as claimed. Thus a repository for employers' references on the internet solving the aforementioned problems is desired.

### BRIEF DESCRIPTION OF THE DRAWINGS

FIG. 1 is an overall system view flow chart for employers according to the present invention.

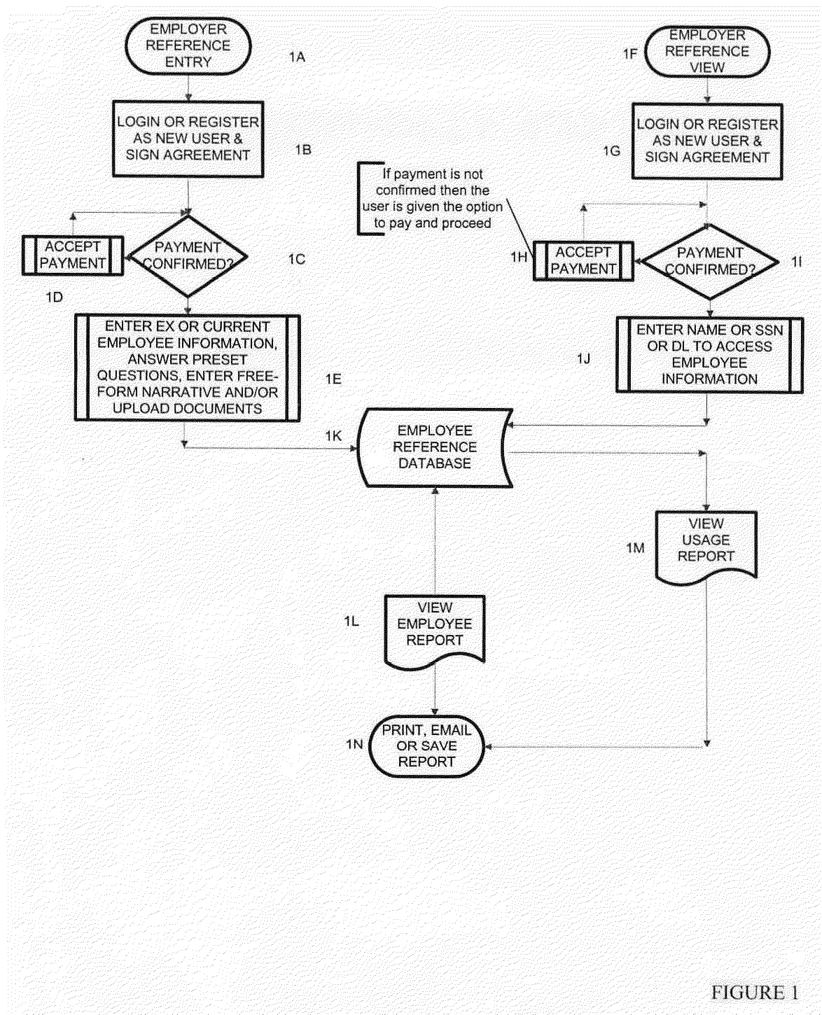

FIG. 2 is an overall system view flow chart for employees according to the present invention.

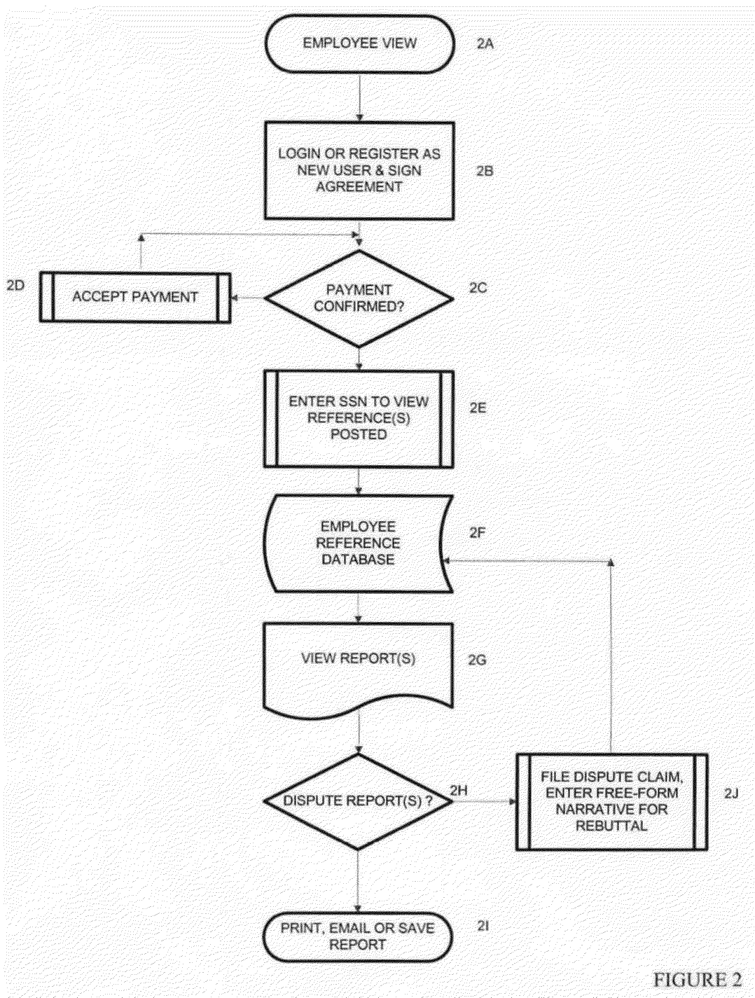

FIG. 3 is the repository website screen illustrating the employer and employer login page according to the present invention.

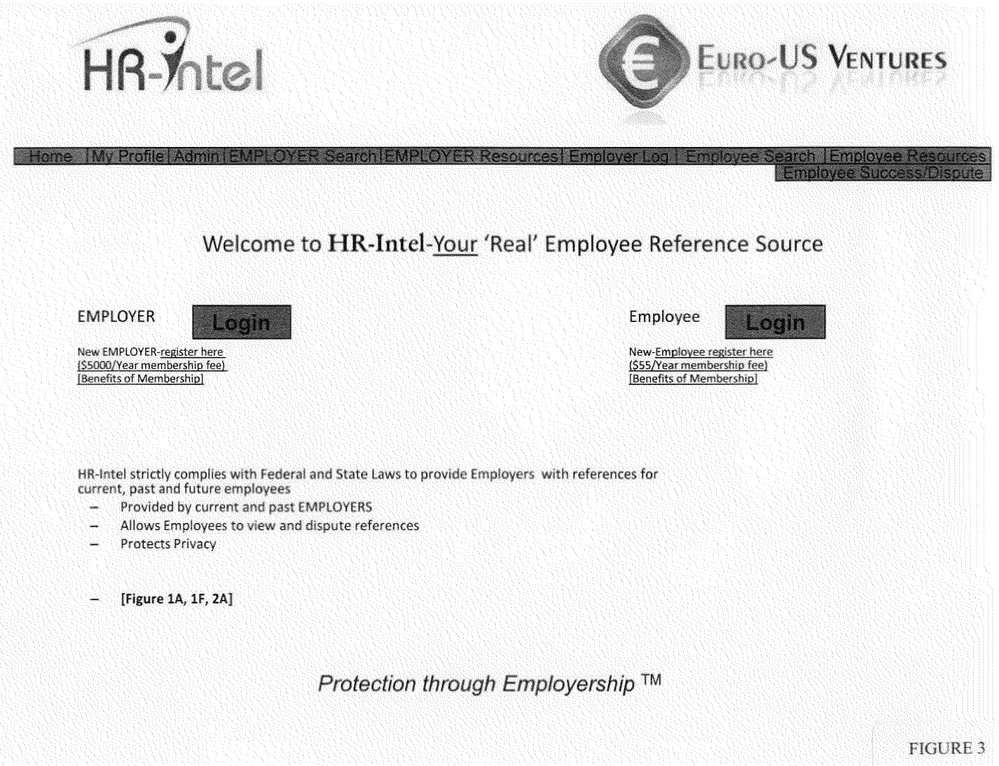

FIG. 4 is the repository website screen illustrating the employer entry screen for new references according to the present invention.

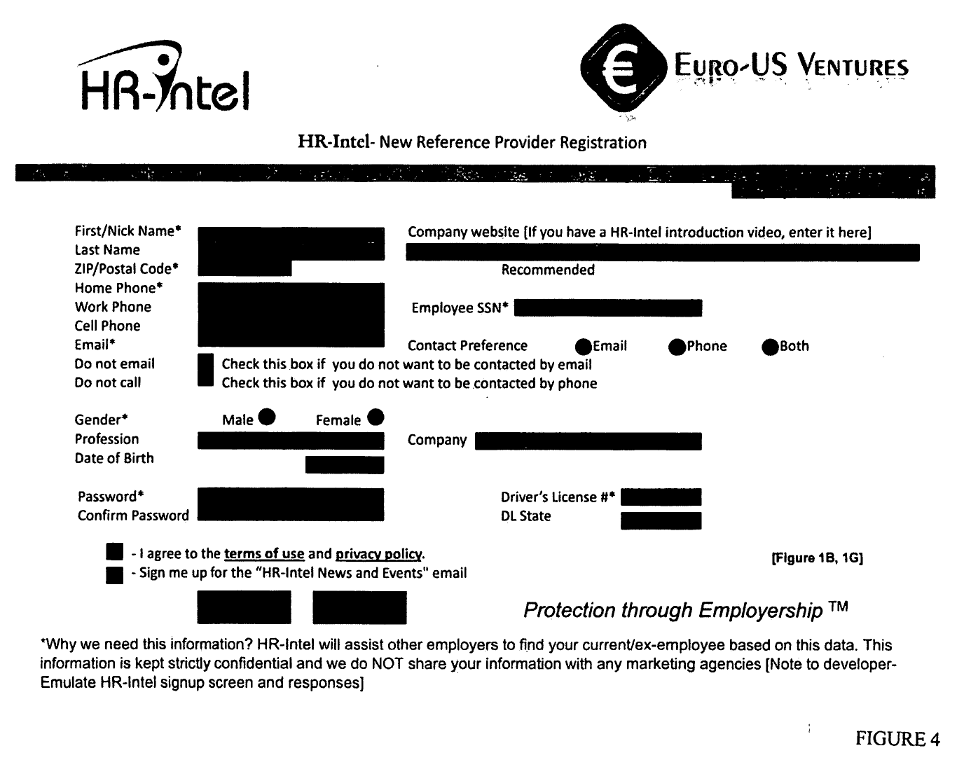

FIG. 5 is the repository website screen illustrating the employee registration screen according to the present invention.

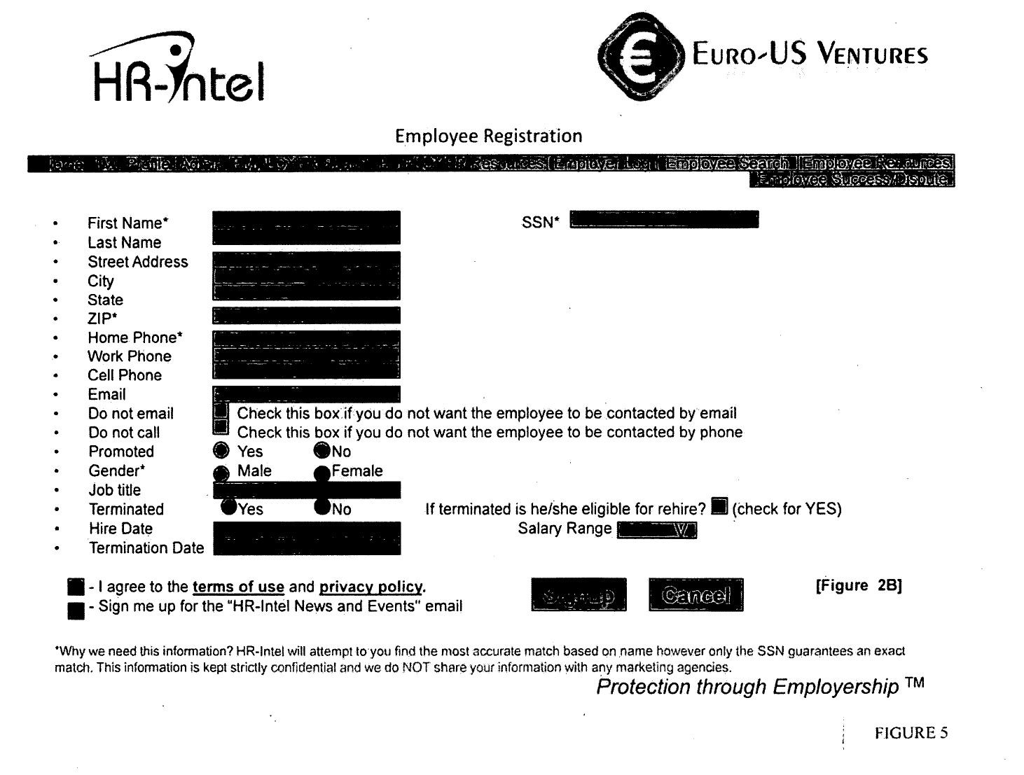

FIG. 6 is the repository website screen illustrating the employee registration agreement terms and conditions according to the present invention.

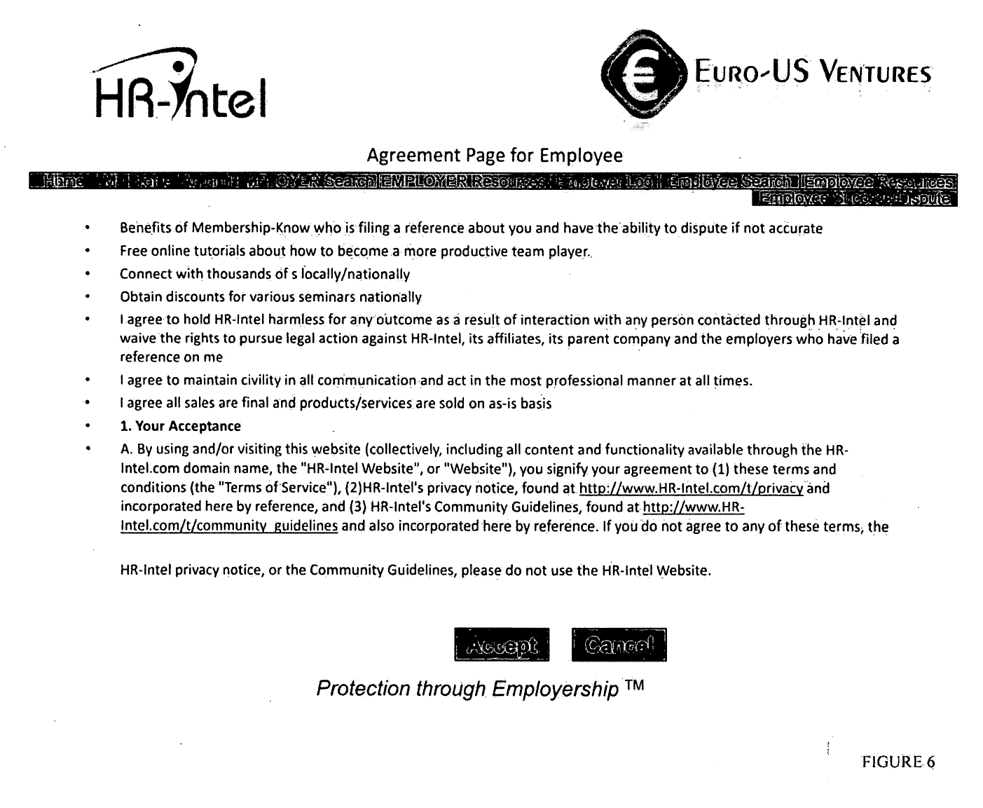

FIG. 7 is the repository website screen illustrating the employer registration agreement terms and conditions according to the present invention.

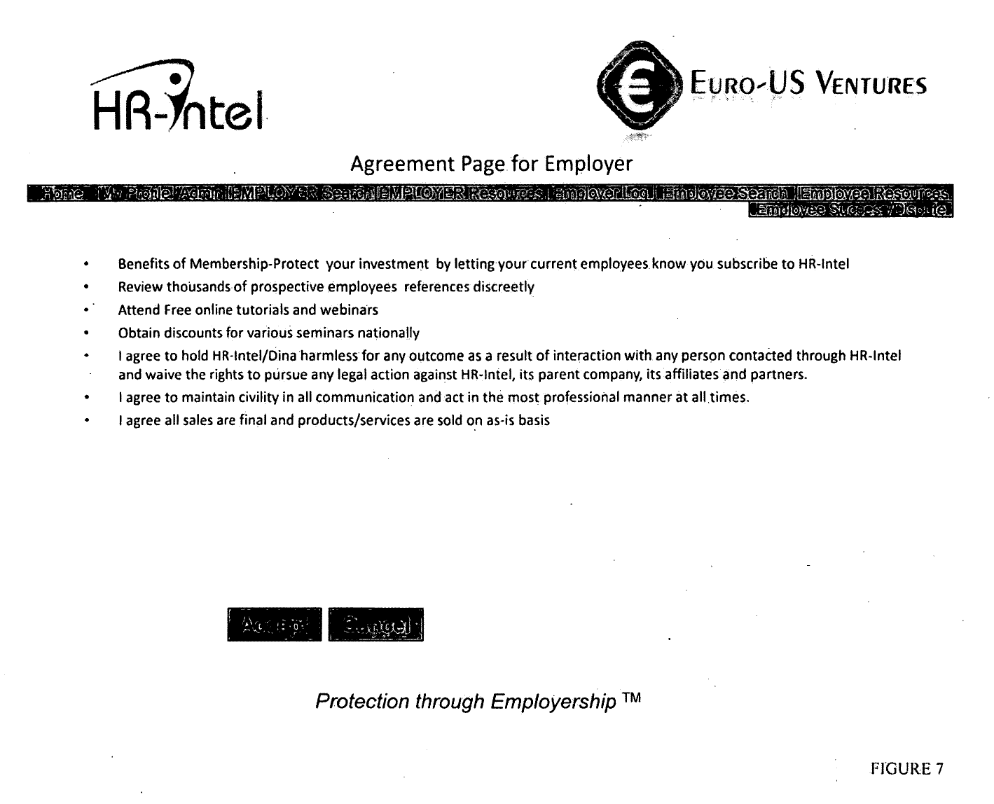

FIG. 8 is the repository website screen illustrating the employer membership registration and payment according to the present invention.

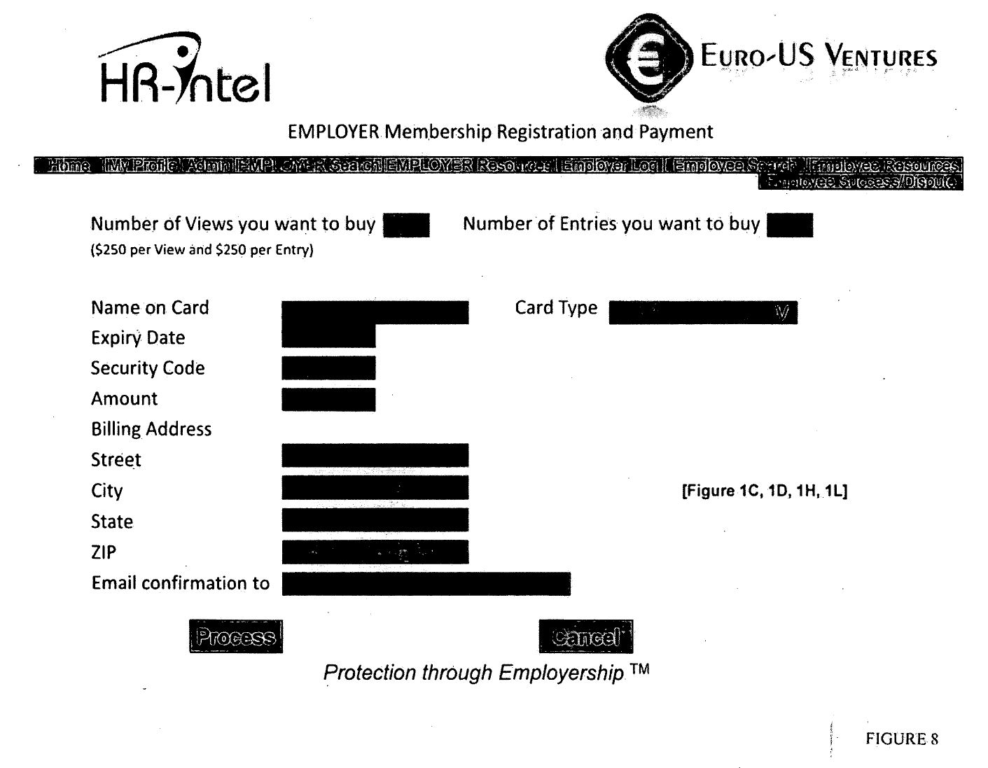

FIG. 9 is the repository website screen illustrating the employee membership registration and payment according to the present invention.

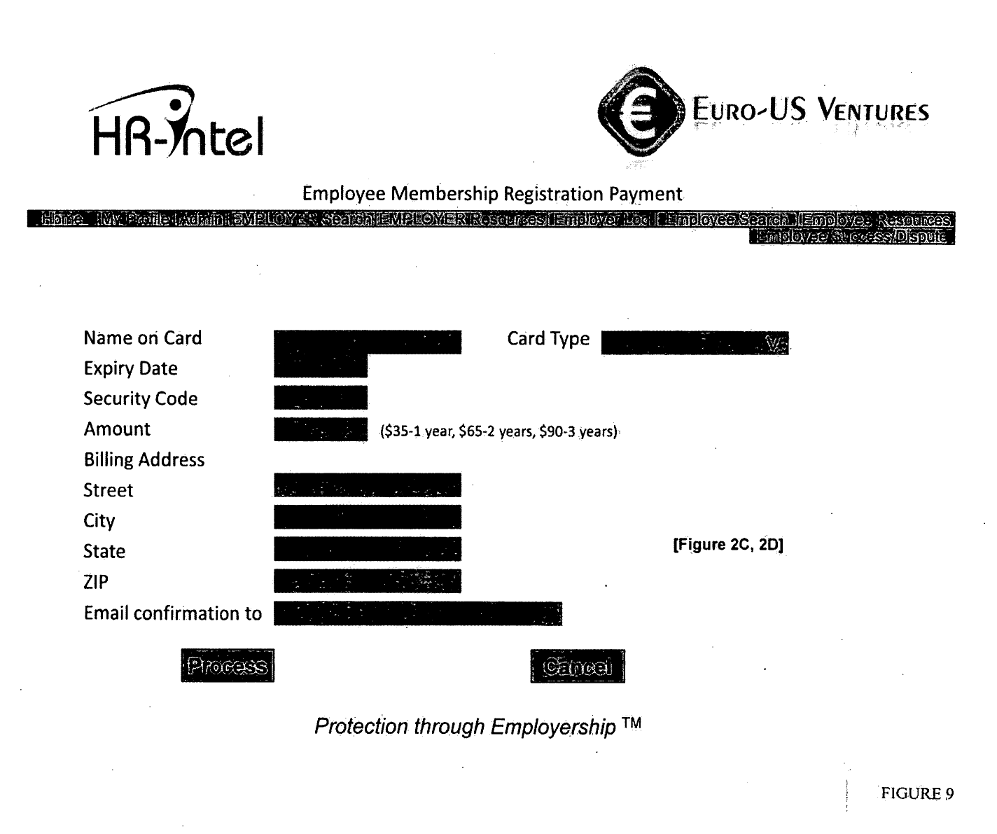

FIG. 10 is the repository website screen illustrating the employer account administration maintenance page according to the present invention.

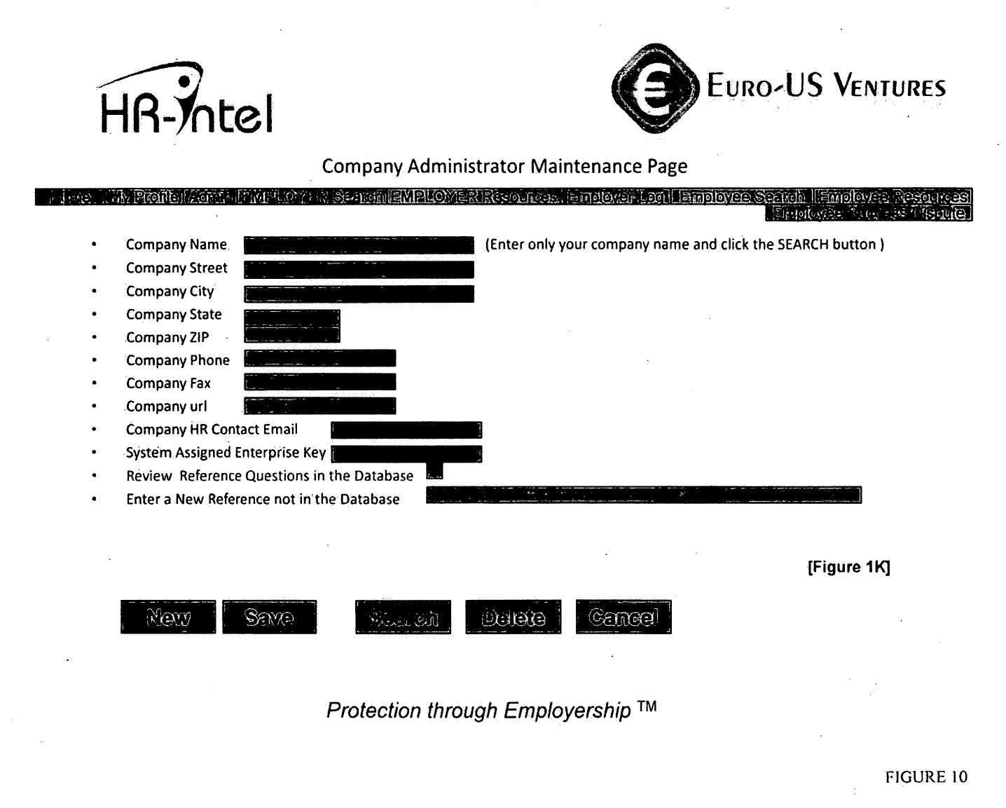

FIG. 11 is the repository website screen illustrating the employer search screen for employer provided employee references on designated employees according to the present invention.

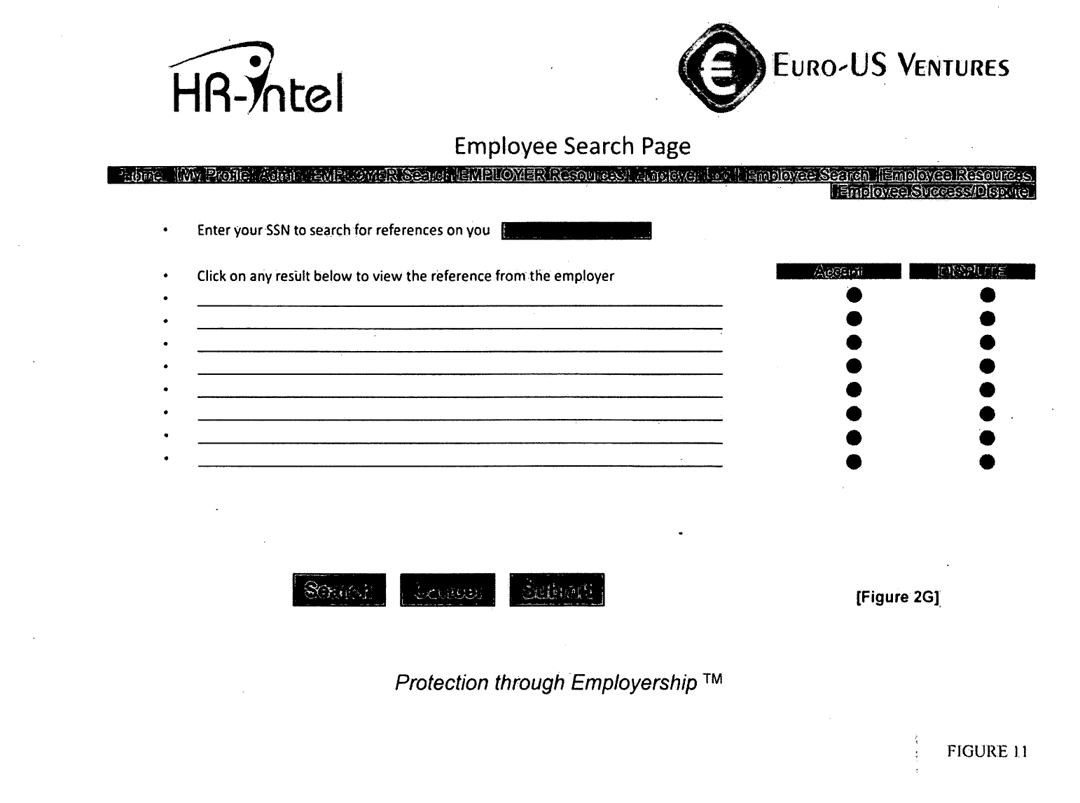

FIG. 12 is the repository website screen illustrating the employer results screen for employees after employer has searched for employee provided references on designated employees according to the present invention.

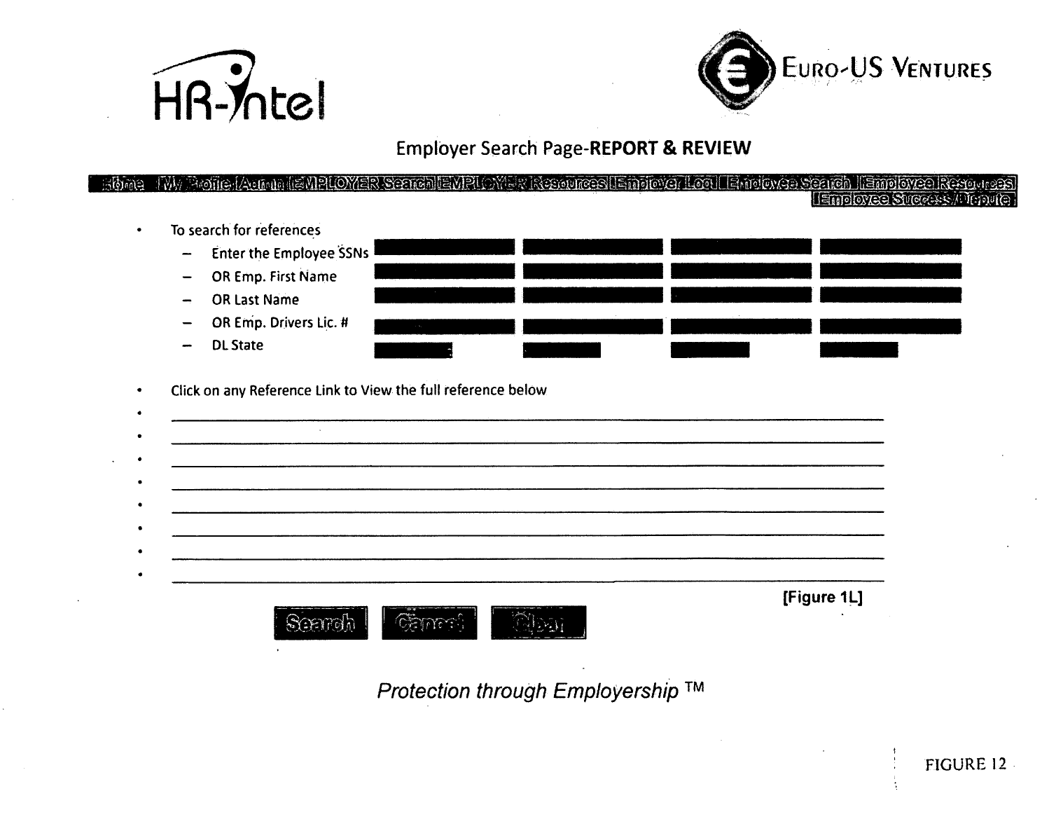

FIG. 13 is the repository website screen illustrating a free form narrative for an employer to upload employee performance information, success or failures according to the present invention.

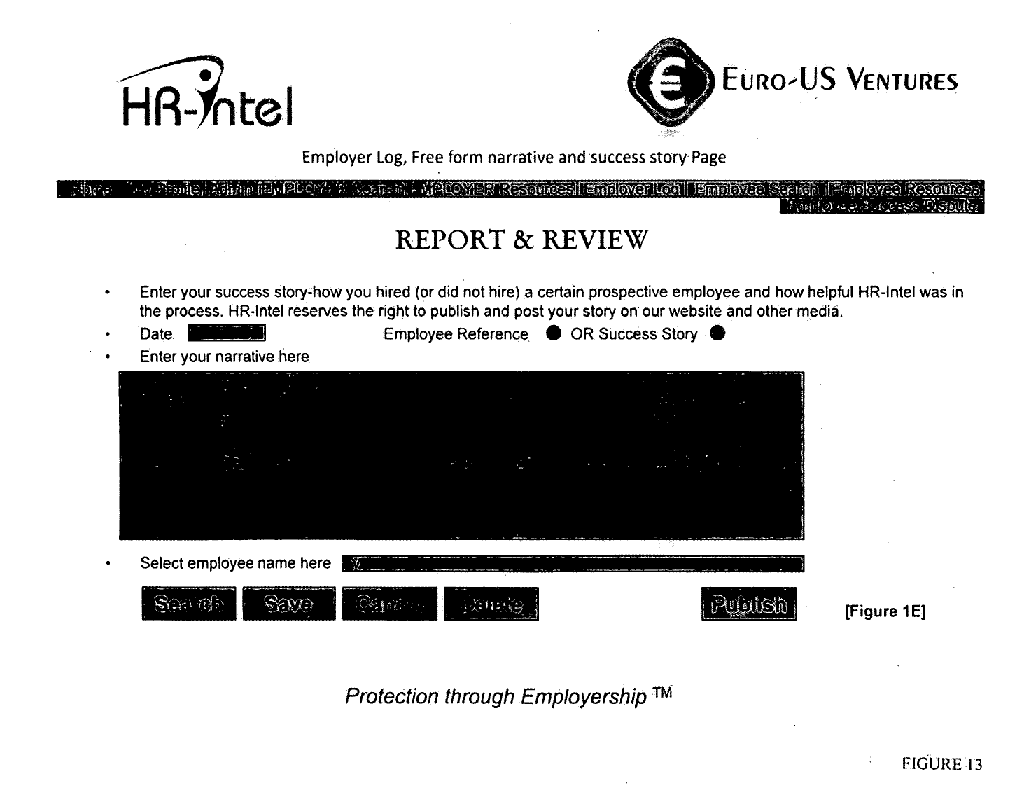

FIG. 14 is the repository website screen illustrating a free form narrative for an employee to upload a dispute to employer provided performance information, employer reference or reference document according to the present invention.

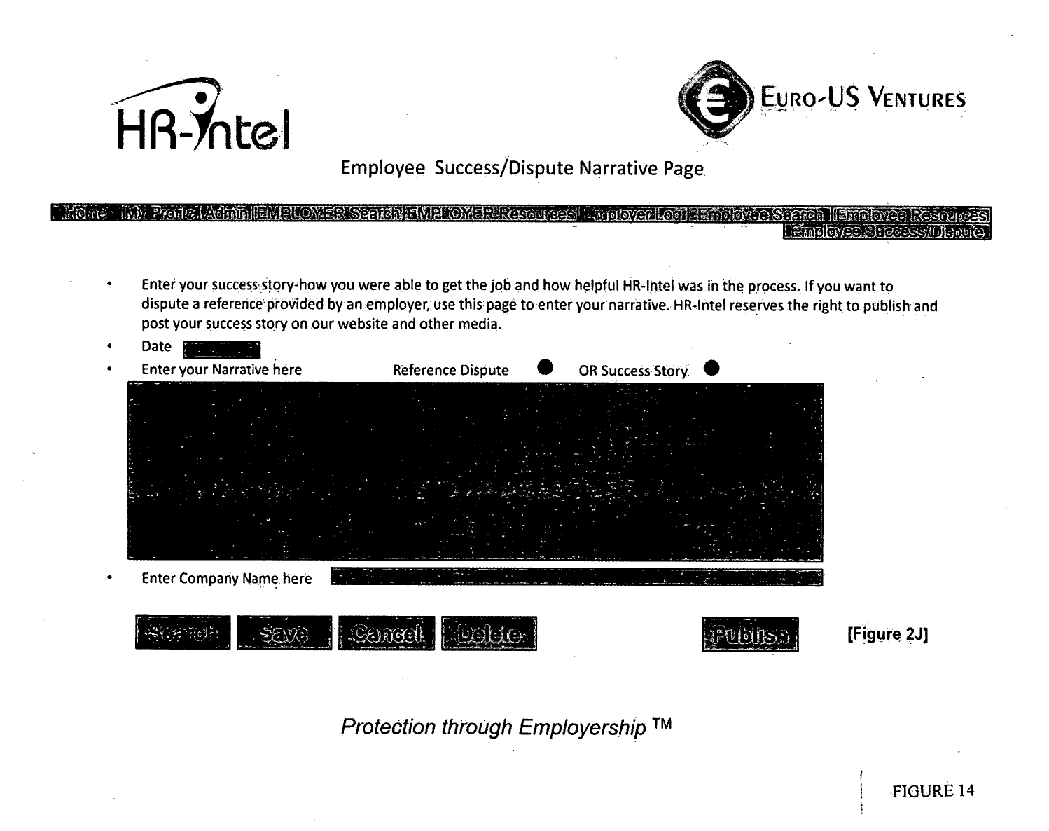

FIG. 15 is the repository website screen illustrating employer provided employee performance according to the present invention.

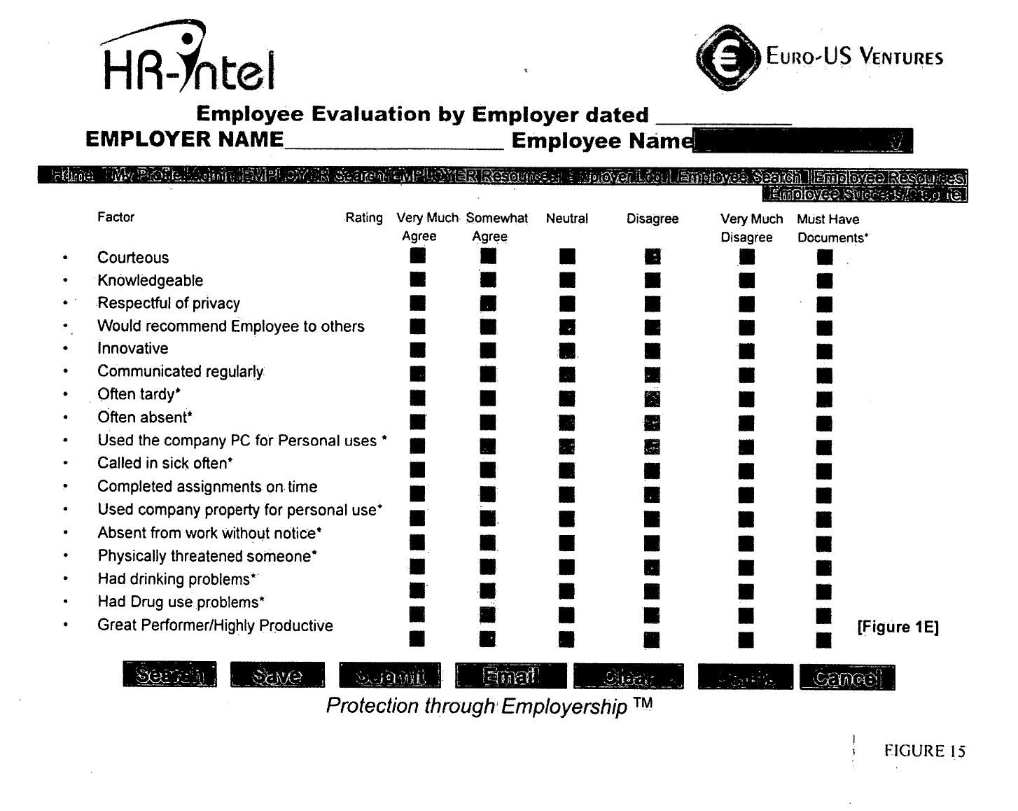

FIG. 16 is the repository website screen illustrating employer upload reference documents according to the present invention.

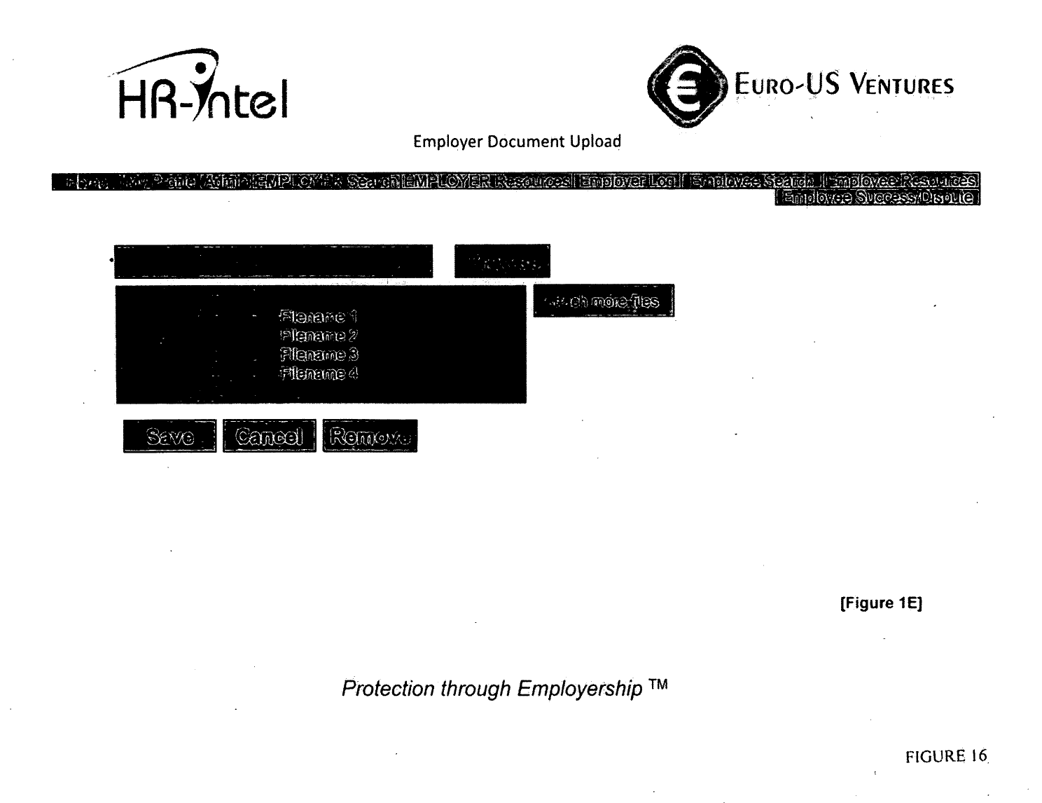

FIG. 17 is the repository website screen illustrating employer usage reports according to the present invention.

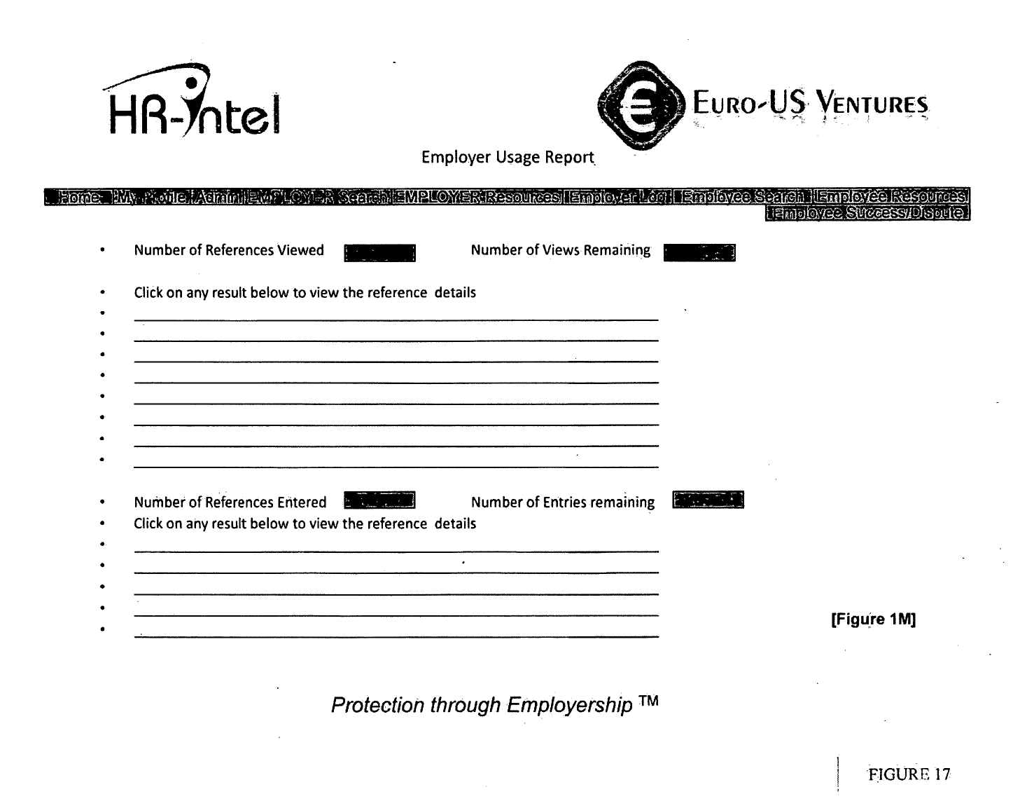

What is claimed is:

1. A reference repository system for employer's on the Internet comprising: An employer computer in two-way communication with said Internet; an employee computer in two-way communication with said Internet; an employer reference server in two-way communication said Internet; and a database in two-way communication with said employer reference server; whereby the employer, through said employer computer, uploads said employer's employee performance information, employee references and employee reference documents to said employer reference server for entry into said database, said employer reference server, upon receiving each said employee performance information, employee references and employee reference documents from said employer, indexes and stores said employee performance information, employee references and reference documents into said database on said server; whereby the employee accesses and receives images of his or her employer uploaded employee performance information, employee references and employee reference documents upon payment of a preset fee, and said employee registers employee disputes to said employee performance information, employee references and employee reference documents, such employee disputes uploaded, indexed and stored into said database on said server; whereby said employer accesses and receives images of desired employee performance information, employee references, employee reference documents and employee disputes upon payment of a preset fee; whereby said employers and said employees are notified upon logon to the employer reference server of uploaded and available employee performance information, employee references, employee reference documents and employee disputes.

2. The reference repository system of claim 1, wherein said employer is selected from the group consisting of a former employer of said employee, a current employer of said employee, and a prospective employer of said employee.

3. The reference repository system of claim 1, wherein said employee is selected from the group consisting of a former employee of said employer, a current employee of said employer, and a prospective employee of said employer.

4. The reference repository system of claim 2 or 3, further comprising means establishing a merchant account in two-way communication with said employer reference server, over the internet with said employer computer, whereby said employer purchases images of said employee performance information, employee references, employee reference documents and employee disputes for electronic delivery from said database of said employer reference server.

5. The reference repository system of claim 2 or 3, further comprising means establishing a merchant account in two-way communication with said employer reference server, over the internet with said employee computer, whereby said employee purchases images of his or her own employee performance information, employee references, employee reference documents and employee disputes for electronic delivery from said database of said employer reference server.

6. A method of providing a repository for employer provided references on the internet comprising: providing an internet home page in a website for access to said repository by employers or employees; providing a process for the employer, accessible from said home page, for registration and upload of employee performance information, employee references and employee reference documents, an ability to update and maintain employer account information; providing a process for said employer, accessible from said home page, to search for said employee performance information, employee references, employee reference documents, and employee disputes whereby said employer purchases for electronic delivery employee performance information, employee references, employee reference documents and employee disputes for a preset fee; providing a process for said employees, accessible from said home page, for registration, review and dispute his or her own employer provided employee performance information, employee references and employee reference documents, purchase for electronic delivery his or her own employee performance information, employee references, employee reference documents and employee disputes for a preset fee, and an ability to update and maintain employee account information.

7. The method of claim 6, wherein said employer is provided a process for being assigned a password, said password allowing said employers to upload, modify, and deleted employee performance information, employee references and employee reference documents after receipt of payment.

8. The method of claim 7, wherein said employer is provided a process for accepting terms of use and being assigned a user identification number and a password for entering into said repository site.

9. The method of claim 8, wherein said employer is provided a process to select and purchase formatted employee performance information, employee references, employee reference documents, and employee disputes from said repository site, said selected references being delivered electronically to said employer.

10. The method of claim 9, wherein a process is provided for said employer to open a merchant account, whereby said formatted employee performance information, employee references, employee reference documents, and employee disputes are purchased.

11. The method of claim 6, wherein said employer is provided a process for uploading employee performance information, employee references and employee reference documents.

12. The method of claim 6, wherein said employer is provided a process for modifying its own previously uploaded employee performance information, employee references and employee reference documents.

13. The method of claim 6, wherein said employer is provided a process for deleting its own previously uploaded employee performance information, employee references and employee reference documents.

14. The method of claim 6, wherein said website assigns unique user identification and a unique password for each employer and employee.

15. The method of claim 14, wherein a process is provided precluding said employer from altering said employee performance information, employee references and employee reference documents which were not originally uploaded by said employer.

16. The method of claim 6, wherein said employee is provided a process for being assigned a password, said password allowing said employee to upload, modify, and deleted employee disputes to employer uploaded employee performance information, employee references, and employee reference documents.

17. The method of claim 16, wherein said employee is provided a process for accepting terms of use and being assigned a user identification number and a password for entering into said repository site.

18. The method of claim 17, wherein said employee is provided a process to select and purchase his or her own formatted employee performance information, employee references, and employee reference documents from said repository site, said selected references being delivered electronically to said employee.

19. The method of claim 18, wherein a process is provided for said employee to open a merchant account, whereby said formatted employee performance information, employee references, and employee reference documents are purchased.

20. The method of claim 19, wherein said employee is provided a process for disputing employer uploaded employee performance information, employee references, and employee reference documents without charge.

21. The method of claim 20, wherein said employee is provided a process for modifying his or her own disputes to employer uploaded employee performance information, employee references, and employee reference documents.

22. The method of claim 21, wherein said employee is provided a process for deleting his or her own disputes to employer uploaded employee performance information, employee references, and employee reference documents.

23. The method of claim 14, wherein a process is provided precluding said employee from altering said employee performance information, employee references, and employee reference documents and employee disputes which were not originally uploaded by said employee.

24. The method of claim 8, wherein said employer is provided a process for receiving an employer account usage report for said employer's usage of said repository site, said usage report being delivered electronically to said employer.
